(19) United States
(12) Patent Application Publication
(10) Pub. No.: US 2024/0179386 A1
(43) Pub. Date: May 30, 2024

(54) ENVIRONMENT MONITORING SYSTEM

(71) Applicant: OCUVERA LLC, Lincoln, NE (US)

(72) Inventors: Hari Wiguna, Lincoln, NE (US); Steve Kiene, Lincoln, NE (US); Lucas A. Sabalka, Lincoln, NE (US)

(21) Appl. No.: 18/551,701

(22) PCT Filed: Apr. 22, 2022
(86) PCT No.: PCT/US22/25893

§ 371 Date: Sep. 21, 2023

Related U.S. Application Data
(60) Provisional application No. 63/178,853, filed on Apr. 23, 2021.

(51) Int. Cl. H04N 23/51; H04N 7/18

(52) U.S. Cl. CPC H04N 23/51; H04N 7/18

(57) ABSTRACT

In an example implementation, a monitoring system is disclosed. The monitoring system can include a camera enclosure including a camera configured to capture images within a field-of-view of the camera and an enclosure including at least a processor, a memory, and a display. The enclosure defines an aperture to provide access to the display. The monitoring system can also include a connector that connects the camera enclosure and the enclosure, wherein a height of the connector ranges from approximately fifty percent (50%) to approximately sixty-five percent (65%) of a total height.

### BACKGROUND

Cameras are configured to capture images within the camera's field-of-view. Cameras may be configured to capture data representing color frame images, such as Red-Green-Blue cameras, and/or configured to capture data representing depth frame images. In some configurations, cameras configured to capture depth frame data transmit a near-infrared light over a portion of the camera's field-of-view and determine a time of flight associated with the transmitted light. In other implementations, the depth may be determined by projecting a structured pattern of infrared light and determining depth from an infrared camera utilizing suitable parallax techniques.

### SUMMARY

In an example implementation, a monitoring system is disclosed. The monitoring system can include a camera enclosure including a camera configured to capture images within a field-of-view of the camera and an enclosure including at least a processor, a memory, and a display. The enclosure defines an aperture to provide access to the display. The monitoring system can also include a connector that connects the camera enclosure and the enclosure, wherein a height of the connector ranges from approximately fifty percent (50%) to approximately sixty-five percent (65%) of a total height.

In other features, the connector comprises a pipe.

In other features, the height of the connector ranges from fifty-five percent (55%) to approximately sixty percent (60%) of the total height.

In other features, the height of the connector ranges from approximately fifty-seven percent (57%) to approximately fifty-nine (59%) of the total height.

In other features, the total height ranges from approximately six hundred and seventy-five millimeters (675 mm) to approximately seven hundred millimeters (700 mm).

In other features, the connector ranges from approximately four hundred millimeters (400 mm) to approximately four hundred and seven millimeters (407 mm).

In other features, the at least one camera comprises a depth camera.

In other features, the depth camera comprises a Red-Green-Blue depth (RGB-D) camera.

In other features, the display includes a touchscreen.

In other features, the total height of the monitoring system is defined as a measurement from a bottom surface of the enclosure to a top surface of the camera enclosure.

In other features, wherein the computing device includes a network interface, the network interface including at least one of a wireless wide area network component, a wireless local area network component, a wired network component, or a wireless personal area network component.

In other features, the total height ranges from approximately six hundred and seventy-five millimeters (675 mm) to approximately seven hundred millimeters (700 mm), and wherein the connector ranges from approximately four hundred millimeters (400 mm) to approximately four hundred and seven millimeters (407 mm).

In other features, the system further includes at least one of a speaker or a microphone.

In an example implementation, a dock configured to receive a camera enclosure is disclosed. The dock can include a base substrate, a first retaining portion disposed over the base substrate that extends outwardly from the base substrate, and a second retaining portion disposed over the base substrate that extends outwardly from the base substrate. The first retaining portion and the second retaining portion can each define an at least partially curved surface that conforms to a camera enclosure.

In other features, the dock includes an electrical connector configured to interface with a corresponding electrical connector of the camera enclosure.

In other features, the includes memory configured to store a unique identifier.

In other features, the base substrate comprises an injection molded base substrate.

In an example implementation, a carousel configured to retain a plurality of computing devices is disclosed. The carousel can include a base, an outwardly extending portion connected to the base, and a plurality of arms connected to a base arm portion, where each arm includes a retaining portion configured to retain a connector of a computing device. The carousel can also include a plurality of docks, and each dock of the plurality of docks configured to receive and to retain a camera enclosure.

In other features, the base includes a plurality of wheels.

In other features, the carousel includes a plurality of outwardly extending portions arranged in stackable configuration.

### BRIEF DESCRIPTION OF THE DRAWINGS

FIG. 1 is a diagram of an example computing device for monitoring an environment that includes an individual positioned over a support surface.

FIG. 2 is a diagram of the computing device.

FIG. 3 is a diagram of a dock configured to retain a camera portion of the computing device.

FIGS. 4A and 4B illustrate a carousel configured to retain multiple computing devices.

FIGS. 5A and 5B illustrate example electrical connectors.

FIG. 6 is a block diagram that illustrates an example computer architecture.

### DETAILED DESCRIPTION

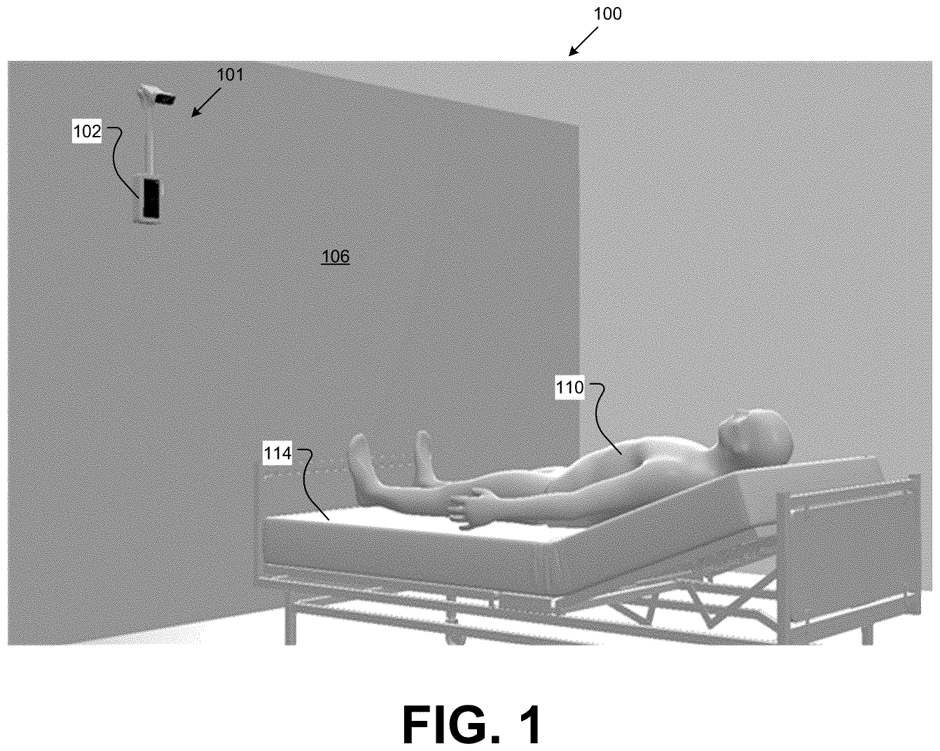

FIG. 1 is a block diagram of an example environment 100 that includes a monitoring system 101. The monitoring system 101 can include a computing device 102, which is explained in greater detail below. As shown, the monitoring system 101 can be mounted to a structure 106, such as a wall. The monitoring system 101 is configured to monitor the environment 100 that can include at least one individual 110, such as a patient, and to predict whether the individual is exiting a support surface 114. While the support surface 114 is illustrated as a bed, it is understood that the support surface 114 may comprise other objects that can support the individual 110, such as a chair.

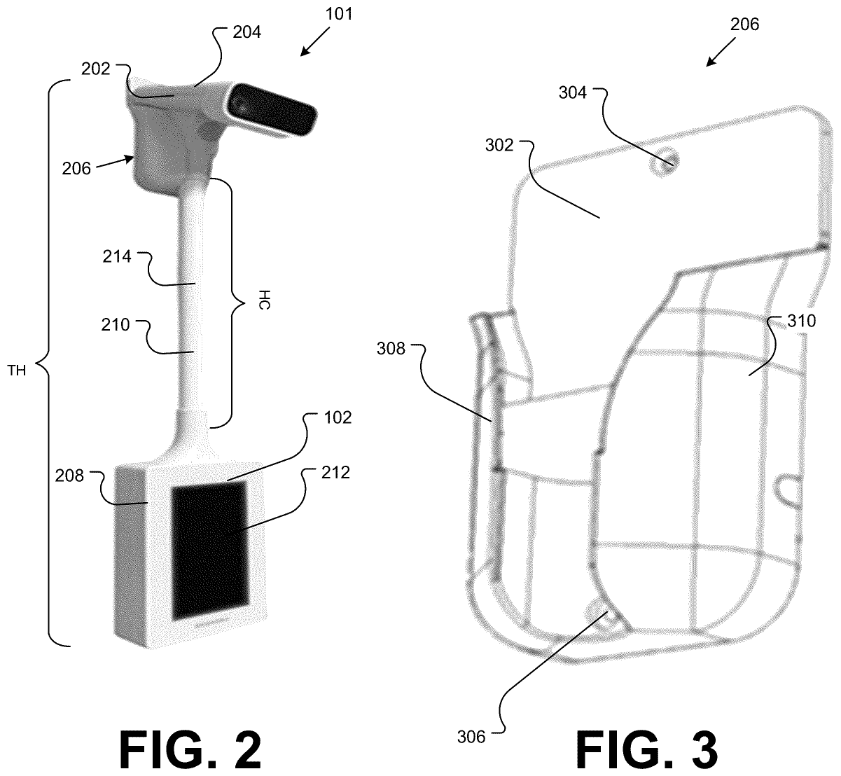

FIG. 2 illustrates an example implementation of the monitoring system 101. As shown, the monitoring system 101 includes one or more cameras 202. The cameras 202 are configured to capture images and per-pixel depth information in a field-of-view (FOV) of the cameras 202. In an implementation, the cameras 202 may be depth cameras, such as Red-Green-Blue depth (RGB-D) cameras operable to capture depth frame image data representing one or more depth frame images and to capture color frame image data representing one or more color (RGB) frame images. In an implementation, the cameras 202 may include, but are not limited to: a near infrared light configured to generate a near infrared light pattern onto the objects within the FOV, a depth frame image complementary-metal-oxide-semiconductor (CMOS) sensor device configured to measure the depth of each object within the FOV, and a color frame image CMOS camera device. For example, RGB-D cameras can identify various objects within the FOV of the cameras 202 and estimate the depth of the identified objects through various depth approximation techniques. For instance, the RGB-D cameras may transmit a structured light pattern in the near-infrared spectrum and utilize suitable parallax techniques to estimate the depth of the objects within the camera's 202 FOV in order to generate depth image data representing one or more depth frame images. Thus, a camera 102 captures data to allow for generation of a depth frame image representing at least partially objects within the camera's 202 FOV. The camera 202 may also be configured to capture color frame image data representing a color frame image at least partially representing objects within the camera's 202 FOV. For example, the depth image may include a two-dimensional (2-D) pixel area of the captured scene where each pixel in the 2-D pixel area may represent a depth value such as a length or distance (e.g., centimeters, millimeters, or the like of an object in the captured scene from the camera 202). In an example implementation, the one or more cameras 202 may comprise a MICROSOFT AZURE KINECT camera.

The components, i.e., electronic components, sensors, video camera, inertial measurement unit (IMU), etc., of the camera 202 may be located within a camera enclosure 204. In an example implementation, the camera enclosure 204 is manufactured from a suitable plastic material. The camera enclosure 204 can be retained within a dock 206, which is described in greater detail below. The dock 206 can be mounted within the environment 100 using one or more fasteners, i.e., screws, nails, etc. For example, the dock 206 can be mounted to the structure 106 such that the camera's 202 FOV includes the support surface 114.

The camera 202 is connected to an enclosure 208 via a connector 210. The enclosure 208 is configured to retain additional components, which are described in greater detail below. The enclosure 208 can define an aperture to provide access to a display 212. In an example implementation, the connector 210 comprises a pipe 214 that can retain one or more wires and/or electrical connectors that connect electrical components of the camera 202 to electrical components retained within the enclosure 208.

Various parameters of the components described herein were selected such that the camera 202 could have an unobstructed view of the environment 100 while the display 212 (including a touchscreen) could be accessible to medical personnel. In various implementations, a height (HC) of the connector 210 ranges from approximately fifty percent (50%) to approximately sixty-five percent (65%) of a total height (TH) of the monitoring system 101. The total height can be measured from a bottom surface of the enclosure 208 to a top surface of the camera enclosure 204. In an example implementation, the height (HC) of the connector 210 ranges from approximately fifty-five percent (55%) to approximately sixty percent (60%) of the total height (TH) of the monitoring system 101. In another example implementation, the height (HC) of the connector 210 ranges from approximately fifty-seven percent (57%) to approximately fifty-nine (59%) of the total height (TH) of the monitoring system 101. For example, the total height (TH) of the monitoring system 101 may range from approximately six hundred and seventy-five millimeters (675 mm) to approximately seven hundred millimeters (700 mm), and the connector 210 ranges from approximately four hundred millimeters (400 mm) to approximately four hundred and seven millimeters (407 mm).

Referring to FIG. 3, the dock 206 includes a base substrate 302 that defines a plurality of apertures 304, 306. The apertures 304, 306 can receive fasteners for mounting the dock 206 to the structure 106. The dock 206 is configured to receive and to retain the monitoring system 101 within the environment 100. A first and a second retaining portion 308, 310 can extend outwardly from the base substrate 302. The retaining portions 308, 310 can comprise an at least partially curved surface that conforms to the camera enclosure 204 and can define a space between the retaining portions 308, 310. As discussed below, the dock 206 can further include one or more electrical connectors that comprise a printed circuit board (PCB). In an example implementation, the base substrate 302 and the retaining portions 304, 306 can be injection molded using suitable plastic materials.

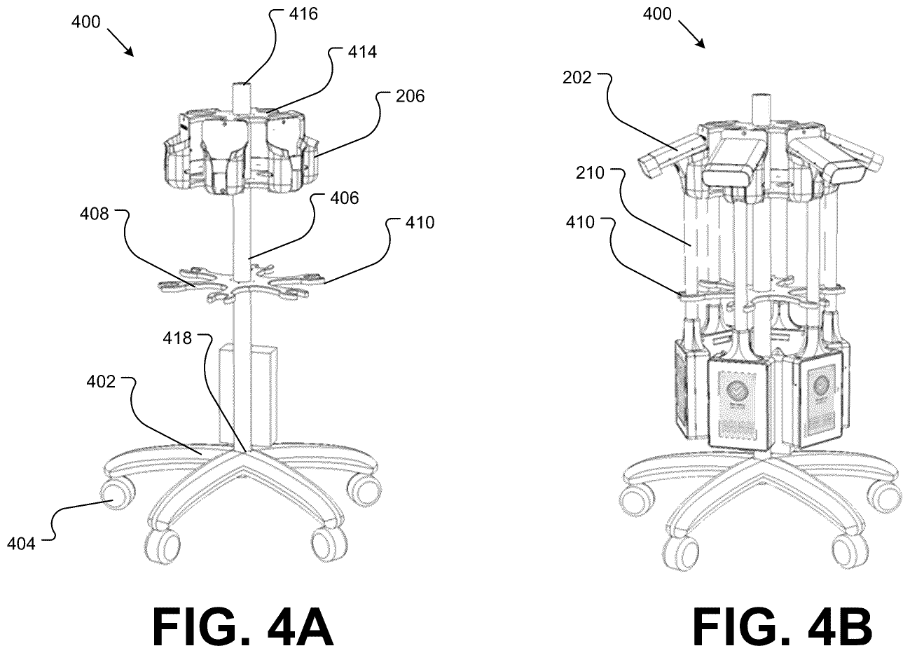

FIGS. 4A and 4B illustrate an example carousel 400 that can retain multiple monitoring systems 101. As shown, the carousel 400 includes a base 402 that includes a plurality of wheels 404. An outwardly extending portion 406 can be connected to the base 402. The outwardly extending portion 406 extends at least substantially perpendicular with respect to a top surface of the base 402. A plurality of arms 408 can extend perpendicularly outward, and each arm 408 can include a retaining portion 410 configured to retain the connector 210 of the computing device 102. The plurality of arms 408 may be connected to a base arm portion 412 that can be detachably connected to the outwardly extending portion 406.

A dock base portion 414 can be detachably connected to a first end 416 of the outwardly extending portion 406 and can be configured to retain a plurality of docks 206. The first end 416 is distal to a second end 418 that interfaces with the base 402. As shown, the dock base portion 414 can include a plurality of docks 206.

As shown in FIG. 4B, the carousel 400 can be configured to one or more monitoring systems 101 for transport between one or more locations. In an example implementation, components of the carousel 400 can be injection molded using suitable plastic materials.

In various implementations, the carousel 400 may be configured as a stackable carousel. For example, in this implementation, a second outwardly extending portion 406 may be configured to interface with the first end 416 of a first outwardly extending portion 406. In other words, the second outwardly extending portion 406 is stacked over the first outwardly extending portion 406 to allow for a two-tier configuration. In the two-tier configuration, additional monitoring systems 101 can be retained by and transported via the stackable carousel.

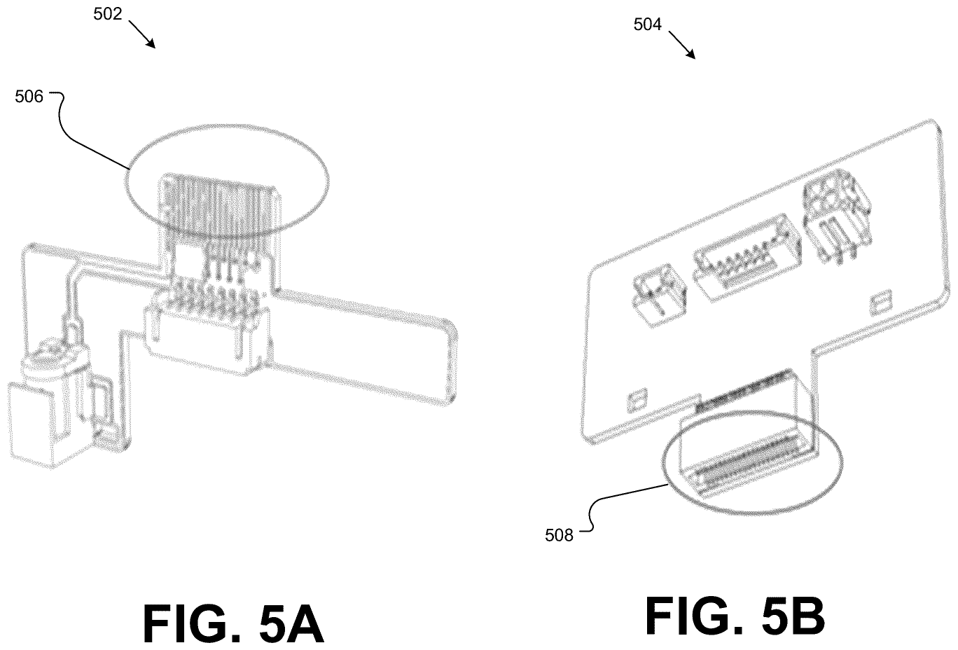

FIGS. 5A and 5B illustrate example electrical connectors 502, 504 for the dock 206 and the camera 202, respectively. The electrical connectors 502, 504 can each comprise a PCB that retains one or more electronic components. As shown, the electrical connector 502 can include male electrical contacts 506 that are configured to interface with a female connector 508 of the camera 202. As discussed below, the electrical connector 502 can include an electronic component, i.e., read-only memory (ROM), that stores a unique identifier corresponding to the dock 206. Once male electrical contact 506 is interfaced with the female connector 508, the computing device 102 can receive the unique identifier from the electrical connector 502 such that the computing device 102 can provide data, e.g., prediction data, to one or more output devices, i.e., smartphones, display 212, etc., corresponding to the unique identifier. The unique identifiers can be mapped to various rooms within a medical facility. In some implementations, interfacing of the male electrical contact 506 and the female connector 508 causes the computing device 102 to enter a boot sequence.

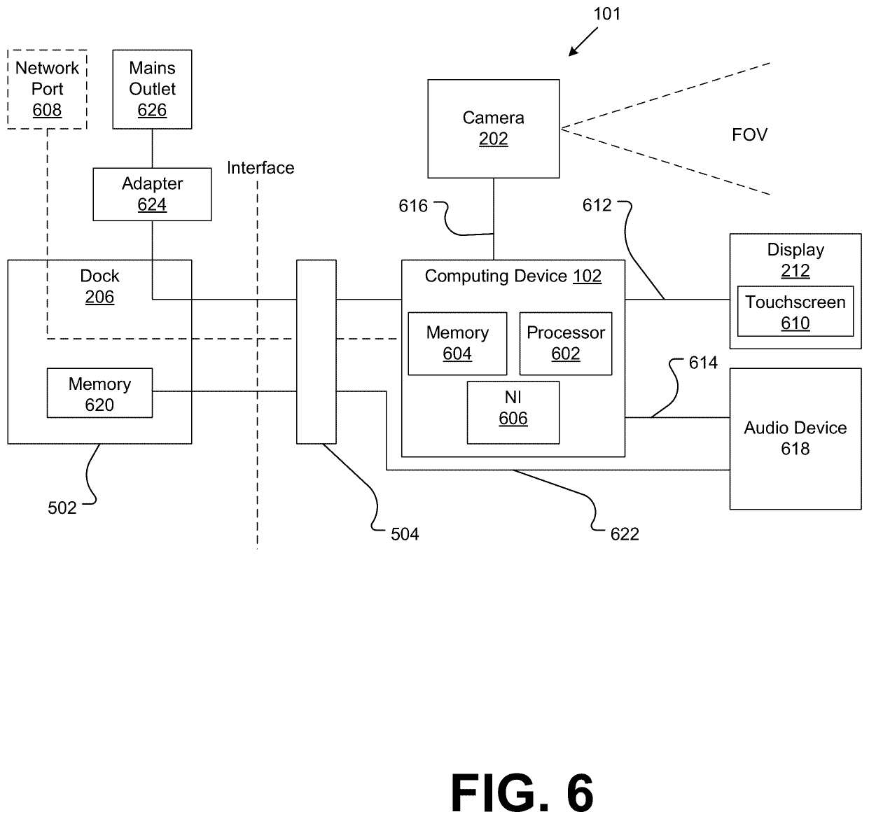

FIG. 6 illustrates an example computing device architecture 600 according to an example implementation. As shown, the computing device architecture 600 includes the computing device 102 and the display 212. The computing device 102 also includes at least one processor 602 and a memory 604. While illustrated as being integral with the processor 602, it is understood that the memory 604 may be standalone with respect to the processor 602.

The processor 602 is capable of executing various software components monitoring an environment, such as a medical environment to predict whether an individual is leaving a support surface, e.g., chair or bed. Aspects of the computing device architecture 600 may be applicable to traditional desktop computers, portable computers (e.g., laptops, notebooks, ultra-portables, and netbooks), server computers, and other computer systems, such as described herein with reference to FIG. 1. For example, the single touch and multi-touch aspects disclosed herein below may be applied to desktop computers that utilize a touchscreen or some other touch-enabled device, such as a touch-enabled track pad or touch-enabled mouse.

The processor 602 includes a central processing unit (“CPU”) configured to process data, execute computer-executable instructions of one or more application programs, and communicate with other components of the computing device architecture 600 in order to perform various functionality described herein. The processor 602 may be utilized to execute aspects of the software components presented herein and, particularly, those that utilize, at least in part, a touch-enabled input.

In some implementations, the processor 602 includes a graphics processing unit (“GPU”) configured to accelerate operations performed by the CPU, including, but not limited to, operations performed by executing general-purpose scientific and engineering computing applications, as well as graphics-intensive computing applications such as high-resolution video (e.g., 720P, 1080P, and greater), video games, three-dimensional (“3D”) modeling applications, and the like. In some implementations, the processor 602 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU. In some example implementations, the processor 602 includes a tensor processing unit (TPU).

The processor 602 may be created in accordance with an ARM architecture, available for license from ARM HOLDINGS of Cambridge, United Kingdom. Alternatively, the processor 602 may be created in accordance with an x86 architecture, such as is available from INTEL CORPORATION of Mountain View, Calif. and others. In some implementations, the processor 602 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above System-on-a-Chip (SoCs), or a proprietary SoC.

The memory 604 can include a random-access memory (“RAM”), a read-only memory (“ROM”), an integrated storage memory (“integrated storage”), and/or a removable storage memory (“removable storage”). It can be understood that the memory 604 can store an operating system. According to various implementations, the operating system includes, but is not limited to, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated. In some implementations, the computer architecture 600 may at least be partially implemented using NVIDIA JETSON components, Coral components, or the like.

The memory 604 is configured to store instructions within a computer-readable medium that causes the processor 602 to monitor a medical environment and to predict whether an individual is attempting to leave a support surface. For example, the processor 602 may be programmed to perform functionality as described in U.S. Pat. Nos. 9,538,158; 10,229,491; 10,229,489; 10,475,206; 10,489,661; 10,496,886; and/or 10,600,204, which are hereby incorporated by reference in their entireties.

The computing device 102 also includes a network interface 606. The network interface 606 can include a wireless wide area network component, a wireless local area network component, a wired network component, and/or a wireless personal area network component. The network interface 606 facilitates communications to and from a communication network, which may be a WWAN, a WLAN, LAN, or a WPAN.

The communication network may be a WWAN, such as a mobile telecommunications network utilizing one or more mobile telecommunications technologies to provide voice and/or data services to a computing device utilizing the computing device architecture 600 via the WWAN component. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the communication network may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The communication network may be configured to provide voice and/or data communications with any combination of the above technologies. The communication network may be configured to or adapted to provide voice and/or data communications in accordance with future generation technologies.

The communication network may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some implementations, the WLAN is implemented utilizing one or more wireless WI-FI access points. In some implementations, one or more of the wireless WI-FI access points are another computing device with connectivity to a WWAN that are functioning as a WI-FI hotspot. The WLAN component is configured to connect to the communication network via the WI-FI access points. Such connections may be secured via various encryption technologies including, but not limited, WI-FI Protected Access (“WPA”), WPA2, Wired Equivalent Privacy (“WEP”), and the like. The communication network may also comprise an Ethernet operating in accordance with IEEE 802.3 that is connectable to the computing device 102 via a network port 608.

The computing device 102 can be connected to the display 212, a touchscreen 610, a data I/O interface (“data I/O”) 612, an audio I/O interface (“audio I/O”) 614, and a video I/O interface (“video I/O”) 616.

In some implementations, the display 212 and the touchscreen 610 are combined. The display 212 is an output device configured to present information in a visual form. In particular, the display 212 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some implementations, the display 212 is a liquid crystal display (“LCD”) utilizing any active or passive matrix technology and any backlighting technology (if used). In some implementations, the display 212 is an organic light emitting diode (“OLED”) display. Other display types are contemplated.

The touchscreen 610 is an input device configured to detect the presence and location of a touch. The touchscreen 610 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some implementations, the touchscreen 610 is incorporated on top of the display 212 as a transparent layer to enable a user to use one or more touches to interact with objects or other information presented on the display 212. In other implementations, the touchscreen 610 is a touch pad incorporated on a surface of the computing device that does not include the display 212. For example, the computing device may have a touchscreen incorporated on top of the display 212 and a touch pad on a surface opposite the display 212.

In some implementations, the touchscreen 610 is a single-touch touchscreen. In other implementations, the touchscreen 610 is a multi-touch touchscreen. In some implementations, the touchscreen 610 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 610. As such, a developer may create gestures that are specific to a particular application program.

In some implementations, the touchscreen 610 supports a tap gesture in which a user taps the touchscreen 610 once on an item presented on the display 212. The tap gesture may be used for various reasons including, but not limited to, opening or launching whatever the user taps. In some implementations, the touchscreen 610 supports a double tap gesture in which a user taps the touchscreen 610 twice on an item presented on the display 212. The double tap gesture may be used for various reasons including, but not limited to, zooming in or zooming out in stages. In some implementations, the touchscreen 610 supports a tap and hold gesture in which a user taps the touchscreen 610 and maintains contact for at least a pre-defined time. The tap and hold gesture may be used for various reasons including, but not limited to, opening a context-specific menu.

In some implementations, the touchscreen 610 supports a pan gesture in which a user places a finger on the touchscreen 610 and maintains contact with the touchscreen 610 while moving the finger on the touchscreen 610. The pan gesture may be used for various reasons including, but not limited to, moving through screens, images, or menus at a controlled rate. Multiple finger pan gestures are also contemplated. In some implementations, the touchscreen 610 supports a flick gesture in which a user swipes a finger in the direction the user wants the screen to move. The flick gesture may be used for various reasons including, but not limited to, scrolling horizontally or vertically through menus or pages. In some implementations, the touchscreen 610 supports a pinch and stretch gesture in which a user makes a pinching motion with two fingers (e.g., thumb and forefinger) on the touchscreen 610 or moves the two fingers apart. The pinch and stretch gesture may be used for various reasons including, but not limited to, zooming gradually in or out of a website, map, or picture.

The data I/O interface 612 is configured to facilitate input of data to the computing device and output of data from the computing device. In some implementations, the data I/O interface 612 includes a connector configured to provide wired connectivity between the computing device and a computer system, for example, for synchronization operation purposes. The connector may be a proprietary connector or a standardized connector such as USB, micro-USB, mini-USB, or the like. In some implementations, the connector is a dock connector for docking the computing device with another device such as a docking station, audio device (e.g., a digital music player), or video device.

The audio I/O interface 614 is configured to provide audio input and/or output capabilities to the computing device. In some implementations, the audio I/O interface 614 is connected to an audio device 618. The audio device 618 can include a microphone configured to collect audio signals and a speaker configured to emit audio signals. As shown, the audio device 618 may also be connected to a memory 620 of the electrical connector 504 via a bus connector 622. As discussed above, once the electrical connector 504 is interfaced with the electrical connector 502, the computing device 102 enters a boot sequence. The unique identifier stored in the memory 620 may be transmitted to the audio device 618. In various implementations, the audio device 618 includes a controller (not shown) that can provide the unique identifier to the processor 602 via the audio I/O interface 614.

The video I/O interface 616 is configured to provide video input and/or output capabilities to the computing device. In some implementations, the video I/O interface 616 includes a video connector configured to receive video as input from another device or send video as output to another device. In some implementations, the video I/O interface 616 includes a High-Definition Multimedia Interface (“HDMI”), mini-HDMI, micro-HDMI, DisplayPort, or proprietary connector to input/output video content.

Although not illustrated, one or more hardware buttons may also be included in the computing device architecture 600. The hardware buttons may be used for controlling some operational aspect of the computing device. The hardware buttons may be dedicated buttons or multi-use buttons. The hardware buttons may be mechanical or sensor-based.

The dock 502 can interface with an adapter 624 that converts electrical power from mains outlet 626 to a voltage suitable for the computing device 102. For example, the dock 502 may include a power connector that interfaces with the adapter 624 and provides power to the computing device 102.

In general, the computing systems and/or devices described may employ any of a number of computer operating systems, including, but by no means limited to, versions and/or varieties of the AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain implementations, and should in no way be construed so as to limit the claims.

Accordingly, it is to be understood that the above description is intended to be illustrative and not restrictive. Many implementations and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future implementations. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A monitoring system comprising:
a camera enclosure including at least one camera configured to capture images within a field-of-view of the camera;
an enclosure including a computing device, the computing device including at least a processor, a memory, and a display, the enclosure defining an aperture to provide access to the display; and
a connector that connects the camera enclosure and the enclosure, wherein a height of the connector ranges from approximately fifty percent (50%) to approximately sixty-five percent (65%) of a total height of the monitoring system.

2. The monitoring system as recited in claim 1, wherein the connector comprises a pipe.

3. The monitoring system as recited in claim 1, wherein the height of the connector ranges from fifty-five percent (55%) to approximately sixty percent (60%) of the total height of the monitoring system.

4. The monitoring system as recited in claim 1, wherein the height of the connector ranges from approximately fifty-seven percent (57%) to approximately fifty-nine (59%) of the total height of the monitoring system.

5. The monitoring system as recited in claim 1, wherein the total height ranges from approximately six hundred and seventy-five millimeters (675 mm) to approximately seven hundred millimeters (700 mm).

6. The monitoring system as recited in claim 1, wherein the connector ranges from approximately four hundred millimeters (400 mm) to approximately four hundred and seven millimeters (407 mm).

7. The monitoring system as recited in claim 1, wherein the at least one camera comprises a depth camera.

8. The monitoring system as recited in claim 7, wherein the depth camera comprises a Red-Green-Blue depth (RGB-D) camera.

9. The monitoring system as recited in claim 1, wherein the display includes a touchscreen.

10. The monitoring system as recited in claim 1, wherein the total height of the monitoring system is defined as a measurement from a bottom surface of the enclosure to a top surface of the camera enclosure.

11. The monitoring system as recited in claim 1, wherein the computing device includes a network interface, the network interface including at least one of a wireless wide area network component, a wireless local area network component, a wired network component, or a wireless personal area network component.

12. The monitoring system as recited in claim 1, wherein the total height ranges from approximately six hundred and seventy-five millimeters (675 mm) to approximately seven hundred millimeters (700 mm), and wherein the connector ranges from approximately four hundred millimeters (400 mm) to approximately four hundred and seven millimeters (407 mm).

13. The monitoring system as recited in claim 1, further comprising at least one of a speaker or a microphone.

14. A dock configured to receive a camera enclosure, comprising:
a base substrate;
a first retaining portion disposed over the base substrate that extends outwardly from the base substrate; and
a second retaining portion disposed over the base substrate that extends outwardly from the base substrate,
wherein the first retaining portion and the second retaining portion each define an at least partially curved surface that conforms to a camera enclosure.

15. The dock as recited in claim 14, further comprising an electrical connector configured to interface with a corresponding electrical connector of the camera enclosure.

16. The dock as recited in claim 14, further comprising memory configured to store a unique identifier.

17. The dock as recited in claim 14, wherein the base substrate comprises an injection molded base substrate.

18. A carousel configured to retain a plurality of computing devices, comprising:
a base;
an outwardly extending portion connected to the base;
a plurality of arms connected to a base arm portion, where each arm includes a retaining portion configured to retain a connector of a computing device; and
a plurality of docks, each dock of the plurality of docks configured to receive and to retain a camera enclosure.

19. The carousel as recited in claim 18, wherein the base include a plurality of wheels.

20. The carousel as recited in claim 18, wherein the carousel includes a plurality of outwardly extending portions arranged in stackable configuration.
